(19) United States
(12) Patent Application Publication
(10) Pub. No.: US 2003/0024261 A1
(43) Pub. Date: Feb. 6, 2003

(54) Magic air filter

(76) Inventor: Jamshid Jim Shahbaz, Westlake Village, CA (US)

Correspondence Address: Jamshid Jim Shahbaz, 993 Aranmoor Avenue, Westlake Village, CA, 91361, US

(21) Appl. No.: 09/895,628

(22) Filed: Jul. 2, 2001

(51) Int. Cl. F25D 15/00; F25D 23/12; F25D 17/04; B67D 5/62

(52) U.S. Cl. 62/331; 62/317; 62/389

(57) ABSTRACT

An integrated system to filter air, cool air, cool water, and heat water by coupling a filter box with compressors and heat exchangers.

### CROSS-REFERENCE TO RELATED APPLICATION

Not Applicable

### BACKGROUND

1. Field of the Invention

The invention relates to air and water quality, specifically to the cooling, heating and filtration of air and water

### BACKGROUND

2. Description of Prior Art

State of the art window air conditioners now require coils to be outside with resulting loss of energy. This requires a window or otherwise inside air must be pushed outside which loses a lot of energy passing air outside for cooling condensation.

Prior art suffers from the disadvantage that their manufacture requires six (6) separate systems to filter air, humidify air, cool air, refrigerate, cool drinking water and heat water whereas the Magic Air Filter accomplishes the identical objectives with only a single compressor.

### SUMMARY

In accordance with the present invention a Magic Air Filter comprises an integrated system to filter air, humidify air, cool air, cool drinking water, refrigeration cooling, and heat water with but a single compressor.

### OBJECTS AND ADVANTAGES

Accordingly, several objects and advantages of the present invention are:

a. Replacement of six (6) separate systems by a single system;

b. Cheaper operation expense than required by six (6) separate systems;

c. Easier maintenance of a single system than for six (6) separate systems;

d. Greater location flexibility; and

e. Energy savings.

Still further objects and advantages will become apparent from a consideration of the ensuing description and the drawing.

### DRAWING FIGURE

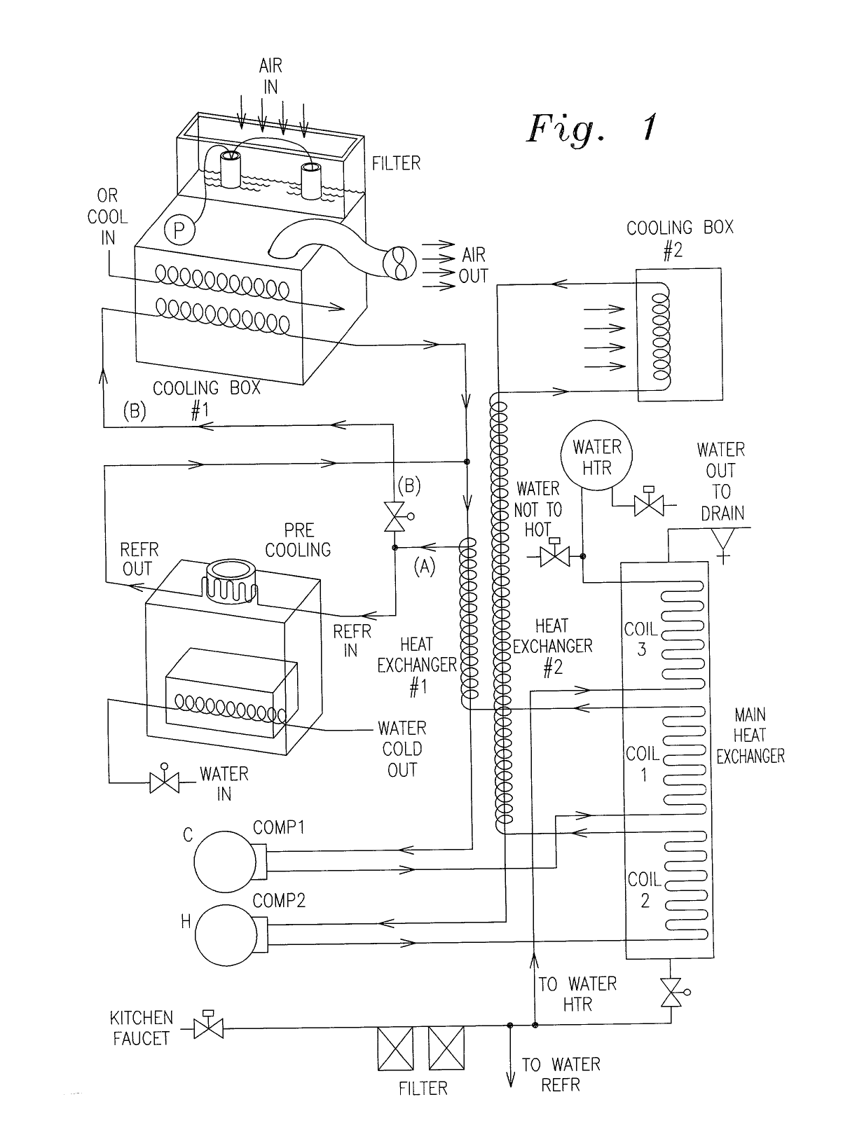

In FIG. 1 there is shown the various aspects of the Magic Air Filter system which encompasses an air filter; humidifier and air filter; air filter, humidifier, air conditioning; air filter, humidifier, air conditioning, refrigerator; air filter, humidifier, air conditioning, refrigerator, cool drinking water and hot drinking water

REFERENCE POINTS IN DRAWING

| | |
|---|---|
| air in: fan pulls air through filter | Air out: filtered clean air exits |
| filter: creates filtration | Water Heater: hot water heater |
| P: pump | (B): solenoid opens refrigeration to air conditioner |
| heat exchanger #1: cooling source | heat exchanger #2: additional cooling source |
| cooling box #1: 2 coils | cooling box #2: 1 optional coil |
| pre-cooling: cools water | (A): freon passes from compressor to refrigerator |
| refr out: freon exits refrigerator | Refr in: freon inside the refrigerator |
| coil 1: compressor 1 condensor | Coil 2: compressor 2 condensor |
| coil 3: water heater preheated water | Water cold out: exited cold drinking water |
| water out to drain: exited hot water | main heat exchanger: creates pre-heated water |
| comp 1: operating refrigerator | Comp 2: 2d stage air conditioner |
| kitchen faucet: water source | To water refr: drinking water connection |

### DESCRIPTION—FIG. 1

A preferred embodiment of the Magic Air Filter of the present invention is illustrated in FIG. 1. The filterfilter encompasses a fan and a pump P which activate two (2) or more spray injector showers. Coil number three coil 3 creates preheated hot water for the water heater water heater.

The main heat exchanger main heat exchanger consists of three coils, coil 1, coil 2, and coil 3. Compressor number one comp I feeds coil number one coil 1 of the main heat exchanger main heat exchanger while compressor number two comp 2 feeds coil number two coil 2 of the same main heat exchanger main heat exchanger.

Two additional heat exchangers follow the main heat exchanger main heat exchanger; one of the two additional heat exchangers heat exchanger #1 fed by compressor #1 comp 1 precedes the refrigerator and the filter filter whereas the second of the two additional heat exchangers heat exchanger #2 is fed by compressor #2 comp 2 and precedes cooling box #2 cooling box #2.

Water is provided through two (2) filters filter from a kitchen faucet kitchen faucet.

A custom water heater water heater and a custom refrigerator complete the Magic Air Filter.

### ADVANTAGES

From the description above, a number of advantages of my Magic Air Filter become evident:

(a) With the use of the Magic Air Filter, one can cool, clean and humidify air by a single system which replaces six (6) separate individual systems otherwise consisting of an air filter, humidifier, air filter humidifier, refrigerator, water cooler, and water heater.

(b) Use of the Magic Air Filter is cheaper than the acquisition of six (6) separate individual systems, otherwise consisting of an air filter, humidifier, air filter humidifier, refrigerator, water cooler, and water heater.

(c) Use of the Magic Air Filter is more easily maintained than the maintenance of six (6) separate individual systems otherwise consisting of an air filter, humidifier, air filter humidifier, refrigerator, water cooler, and water heater.

(d) The Magic Air Filter can be located in any space without the requirement of access to exterior walls; and

(e) Use of the Magic Air Filter requires less energy and resulting lower energy bills than six (6) separate individual systems otherwise consisting of an air filter, humidifier, air filter humidifier, refrigerator, water cooler, and water heater.

(f) Use of the Magic Air Filter requires less space than six (6) separate individual systems otherwise consisting of an air filter, humidifier, air filter humidifier, refrigerator, water cooler, and water heater.

(g) The Magic Air Filter can be used in any house, flower shop, restaurant, large warehouse, or any place involving variable temperatures.

### OPERATION—FIG. 1

The manner of using the Magic Air Filter is illustrated in FIG. 1. The pump P inside the filter filter tank moves water into two (2) or more spray injectors resulting in cooler, wetter washed and cleaner air. The air gets sucked in the air tank air in by a fan which causes the air to exit air out cooler and humidified.

Solenoid (B) (B)is energized if the space requires additional cooling which allows freon to proceed to cooling box #1 cooling box #.The freon passes from compressor number one comp 1 through the main heat exchanger main heat exchanger at coil number one coil 1 to the valve A (A) where the freon is directed to either the air filter cooling box #1 cooling box #1 or the refrigerator—or, partially to both the filter filter or the refrigerator. Implementation of the aforesaid additional cooling is done by the kitchen faucet kitchen faucet or ice maker water supply providing water through two (2) filters whereupon the water is directed to (I) the main heat exchanger main heat exchanger, or (II) to the cold water box inside the refrigerator, or (III) the third coil coil 3 to preheat for the water heater H/W.

Compressor number two comp 2 is activated if the space requires still additional cooling. The freon passes from compressor number two comp 2 through the main heat exchanger main heat exchanger at coil 2 coil 2 to a valve where the freon is directed to either cooling box #2 or the water cooler in the filter which is cooling box number one tank filter.

### CONCLUSION, RAMIFICATIONS, AND SCOPE

Accordingly, the reader will see that the Magic Air Filter of this invention can be used as a single system to replace an air filter, a humidifier, an air filter/humidifier, a refrigerator, a water cooler, and a water heater.

Although the description above contains many specificities, these should not be construed as limiting the scope of the invention but as merely providing illustrations of some of the presently preferred embodiments of this invention.

Thus the scope of the invention should be determined by the appended claims and their legal equivalents.

1. A machine comprising:
a. a filter box to clean, cool, and dehumidify air,
b. An interrelated system of compressors and heat exchangers to move freon through the system, and
c. Means for controllaby coupling the filter box with the compressors and heat exchangers,
d. provision of a choice of cold drinking water, pre-hot drinking water, refrigeration, and air conditioning,
whereby air can be cooled, cleaned and dehumidified.
